(19) United States
(12) Patent Application Publication
(10) Pub. No.: US 2006/0062689 A1
(43) Pub. Date: Mar. 23, 2006

(54) System, method and device for detection of substances on surfaces

(76) Inventors: Kirollos Salama Kirollos, Virginia Beach, VA (US); Gueorgui Milev Mihaylov, Virginia Beach, VA (US); Tesfa M. Tekleab, Norfolk, VA (US)

Correspondence Address: BRADLEY D. GOLDIZEN, 505 SOUTH INDEPENDENCE BOULEVARD, SUITE 102, VIRGINIA BEACH, VA, 23452, US

(21) Appl. No.: 10/944,331

(22) Filed: Sep. 17, 2004

(51) Int. Cl. G01N 31/22

(52) U.S. Cl. 422/58

(57) ABSTRACT

A surface wipe for real time detection of trace amounts of toxic substances on surfaces. The wipe includes a collection surface that is swiped across a surface to be tested. The collection media filters dirt and other materials to prevent or reduce inaccurage readings caused by dirt or other foreign matter. A reactive media next to the collecting surface is impregnated with chemicals that react to the toxic substances to create a color change in the reactive media. The color change may be viewed through a clear backing.

There are no related patent applications.

The patent application did not receive federal research and development funds.

### BACKGROUND OF THE INVENTION

The need for quick and real time detection of trace amounts of toxic substances on surfaces is of great importance to the health of humans and the environment. The current state of the art and the market have a variety of devices designed for the collection of toxic substances from surfaces using suitable cloth or fabrics. The collected material is then sent to a laboratory for identification and quantification of the toxic substances. This requires much time and is unsuitable for readily detecting harmful substances.

Other devices for use in detecting harmful substances include adding suitable calorimetric reagents to a cloth or fabric that has been used to wipe the surface to be tested. The cloth is then visually inspected for a calorimetric identification of the target toxic substance.

U.S. Pat. No. 6,248,593 teaches a method of detecting lead contamination of a surface. A hand wipe is used to collect any lead contamination on the surface. The lead is solubilized with an aqueous acid solution and treated with a suitable calorimetric reagent. A change in color is indicative of the presence of lead. This method is suitable for testing surfaces such as floors, walls, windowsills, and human skin. In this method however, swiping the surface with the hand wipe to collect the targeted toxic substance results in simultaneous collecting of dirt, soil and or dark substances usually found on floors, walls and windowsills. This dirt, soil and/or dark substances masks the color resulting from the reaction between the chemical reagents and the target toxic substance. This constitutes a major drawback for this method especially if it is used in the harsh industrial environments.

Several other methods exist for the detection of Lead and other toxic substances in surfaces. For example, U.S. Pat. No. 5,416,028 (May 16, 1995), U.S. Pat. No. 5,445,965 (Aug. 29, 1995), U.S. Pat. No. 5,496,736 (Mar. 5, 1996), and U.S. Pat. No. 5,567,619 (Oct. 22, 1996) provide methods for determining lead in liquid samples. U.S. Pat. No. 5,039,618 (Aug. 13, 1991), U.S. Pat. No. 5,330,917 (Jul. 19, 1994), U.S. Pat. No. 5,364,792 (Nov. 15, 1994), and U.S. Pat. No. 5,550,061 (Aug. 27, 1996) provide methods for detecting lead using a test swab impregnated with a test reagent. The test swab is rubbed over the surface to be tested; if the toxic substance is present on the tested surface, the swab will exhibit a characteristic color.

One such test swab kit for detecting lead utilizes a rhodizonate ion reaction system. This kit is commercially available and marketed under the brand Lead Check™ from HybrilVet Systems, Inc. of Natick, Mass. In the Lead Check™ system, two reagents (sodium rhodizonate and a tartrate buffer) are contained in glass or plastic tubes separated by an inert spacer. When activated, the reagents are mixed and then used to saturate an absorbent (i.e. cotton) tip of the swab (thereby producing a yellow color). By rubbing the cotton tip over the surface to be tested, the presence of lead can be detected by observing the color of the swab tip (a pink to red color indicates the presence of lead, the lack of any color change indicates the absence of significant levels (e.g., less than about 2 .mug) of lead. However, the Lead Check™ kit suffers from the same problems previously mentioned. Thus, in all the mentioned methods, the collection devise or swab collects dirt, soil and/or dark substances along with the target toxic substance. The calorimetric result observed is on the same area where the dirt, soil and/or dark substances are collected which may result in an inaccurate reading.

### SUMMARY OF THE INVENTION

It is an objective of the present invention to provide a new and improved device and method for assessment of risk of exposure from harmful substances.

Another objective of the invention is to provide an improved, simple and low cost device and method for the real time detection and quantification of a wide range of toxic substances on any surface.

Yet another objective of the present invention is to provide a simple means of detecting trace amounts of toxic substances existing on surfaces covered with dirt, soil and/or dark substances.

Another objective of the present invention is to provide a simple means for accurately collecting and quantifying toxic substances on surfaces.

In accordance with one aspect of the invention, the foregoing and other objectives are achieved by a surface swab capable of collecting, filtering, detecting and quantifying toxic substances on surfaces.

Another aspect of the invention is achieved by a surface swab capable of producing a color result on an opposite side of a collecting surface.

Another aspect of the invention is achieved by a surface swab applicator that evenly collects and distributes a collected substance on a collection member of the surface swab applicator.

Another aspect of the invention is achieved by a predetermined grid printed on one side and/or both side of the surface swab to simplify the quantification of the collected toxic substance.

In one embodiment of the present invention, the surface swab has three main components; the collection member, the reactive member and the clear support member. The collection member is preferably constructed from a porous inert material such as cloth, woven or unwoven fabric or felt having a predetermined pore size preferably between 1 and 40 microns. The cloth, woven or unwoven fabric or felt is preferably constructed from polyester, polypropylene, polyethylene or polyamide. The surface swab has a square, rectangle, round or half rectangle half round shape. The collection member can be impregnated or coated with active ingredient or plurality of active ingredients that can react and/or transform the collected analyte to another substance capable of reacting with the reactive member to produce optochemical result directly or upon the addition of developing substrate before and/or after collecting the analyte.

The reactive member is constructed as boundary layer sandwiched between the clear plastic member and the collection member partially penetrating into the macro-pores of the collection member. The reactive member comprises three main components. An active ingredient or plurality of active ingredient are capable of undergoing chemical and/or biochemical and/or physical reaction(s) when coming into contact with the targeted analyte to produce an optochemical result directly or upon the addition of a developing substrate before and/or after collecting the analyte. A solid support substrate has a predominatly macro porous structure to support and encapsulate the chemical and/or biochemical active ingredients. A binding substrate or plurality of binding substrates binds the particles of the solid support substrate together and to the clear support member and the collection member.

The chemical and/or biochemical formulations may or may not include a binding substrate to bind and/or localize the chemical and/or biochemical active ingredients to the micro porous and/or nonporous support substrate.

The micro porous and/or nonporous support substrate is preferably silica, alumina, zeolite porcelain or any similar inert materials that are compatible with the chemical and/or biochemical active ingredients. The reactive member can also be constructed from filter paper or any porous inert membranes impregnated with active ingredients capable of undergoing chemical and/or biochemical and/or physical reaction(s) with the targeted analyte to produce an optochemical result directly or upon the addition of a developing substrate before and/or after collecting the analyte. The porous membranes is preferably constructed from polyesters, polyamides, polyethylene, nitrocellulose, Teflon or alike polymeric substances.

The clear support member is preferably constructed from polypropylene, polyesters, polycarbonates, polyamides or any clear inert polymer. The preferred thickness of the clear support member is preferably between 5 and 25 mils.

In use, the collection member of the surface swab is drawn into contact with a surface to be tested. Openings provided in the collection member allow materials to be tested to penetrate and fill part of the collection member and to contact the reactive member causing a color change that may be viewed through the clear support member. Thus, dirt, grime and the like do not affect the operation of the surface wipe since the color change may be viewed from an opposite side of reactive member.

### BRIEF DESCRIPTION OF THE DRAWINGS

FIG. 1 is a perspective view of a first embodiment of the surface wipe of the present invention.

FIG. 2 is an exploded view of FIG. 1 and showing the arrangement of elements.

FIG. 3 is a perspective view of a second embodiment of the surface wipe.

FIG. 4 is an exploded view of another embodiment of the surface wipe.

FIG. 5 is another embodiment of the present invention.

FIG. 6A is an enlarged partial elevation view of a FIG. 6B and includes mesh.

FIG. 6B is a partial elevation view of another embodiment of the invention.

FIGS. 7A and 7B depict various views of a further embodiment of the invention.

FIGS. 8A and 8B show grids provided on the upper surface of the device for use in estimating the amount of contamination on a surface.

FIGS. 9A and 9B are different embodiments of holders for use with the device.

FIGS. 10A-C are further embodiments of transparent holders for accommodating different shaped swabs.

FIG. 11 shows a method of using the device without a holder.

### DETAILED DESCRIPTION OF THE INVENTION

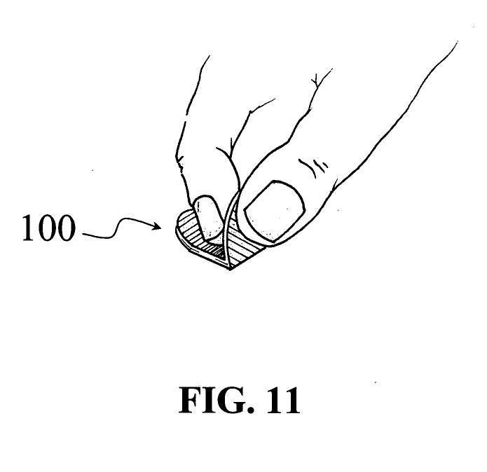

The present invention is a surface swipe for detecting harmful substances on a surface and generally indicated as 100 in the figures. The surface swipe 100 includes a collection member 120, a reactive member 130 and a clear backing 140. A grip 150 for use as shown in FIG. 11 may also be included on the side of the surface swipe opposite the collection member.

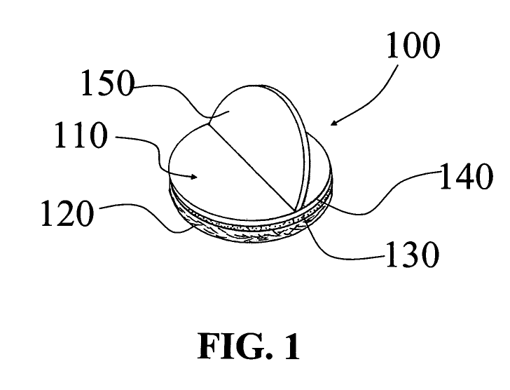

Collection member 120 preferably comprises a porous inert material. Such material may comprise cloth, felt, woven fabric, blended fabric, a composite or unwoven fabric. The material preferably comprises polyester, polypropylene, polyethylene or a polymide. Collection member 120 may be shaped in different shapes such as square, rectangle, round or a combination thereof. The collection member 120 may be impregnated with an active ingredient or a plurality of active ingredients that react with or transform collected analyte to another substance capable of reacting with the reactive member 130. In FIG. 1, the collection member 120 is disposed next to reactive member 130 and operates as a filter to prevent dirt and other contaminates from contacting the reactive member 130.

Reactive member 130 preferably comprises at least one active ingredient that reacts to a harmful substance, a carrier member and a binding member. The active ingredient undergoes a chemical, biochemical, physical reaction or combination thereof with a targeted harmful substance or analyte to produce an optochemical or color change result when the harmful substance is contacted. The reactive member 130 includes a support substrate that comprises macro porous structure to support and encapsulate the active ingredients. As shown in FIG. 1, the reactive member 130 is sandwiched between the collection member 120 and the clear backing 140.

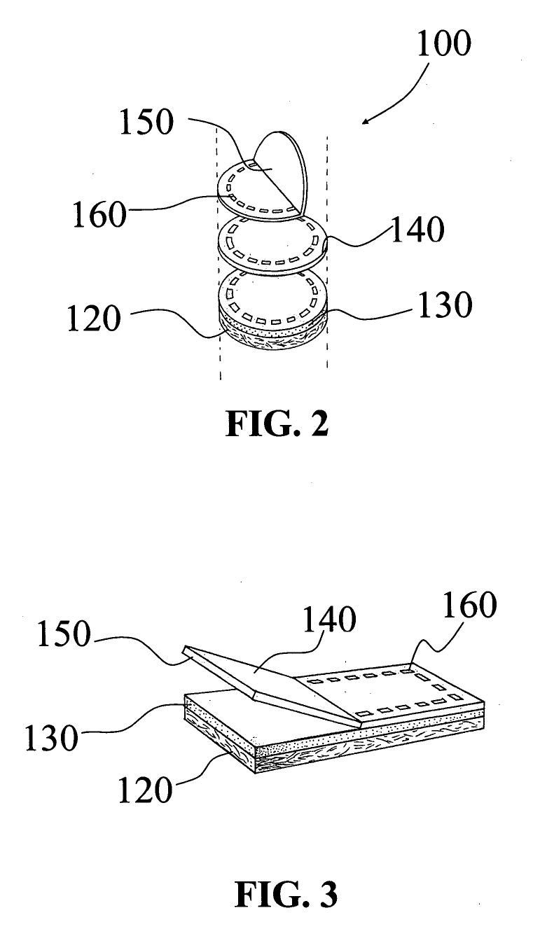

The clear backing 140 comprises an upper surface 110 through which a color change or optochemical reaction in the reactive member 130 is viewed. The clear backing preferably comprises polyproplylene, polyesters, polycarbonateds, polyamides, any clear inert polymer or combinations thereof in a preferable thickness of between 5 and 25 mils. A grip 150 is provided on the upper surface 110 of the clear backing 140. Seams 160 or points of attachment 160 are provided as shown in FIGS. 2 and 3 are provided for securing the different elements of the swab 100 together.

In FIG. 3, grip 150 is incorporated into the clear backing 140 as shown. Thus, a portion of the clear backing 140 actually forms the grip 150. During use, the clear backing 140 is pulled away from the reactive member 130 to form grip 150, as shown.

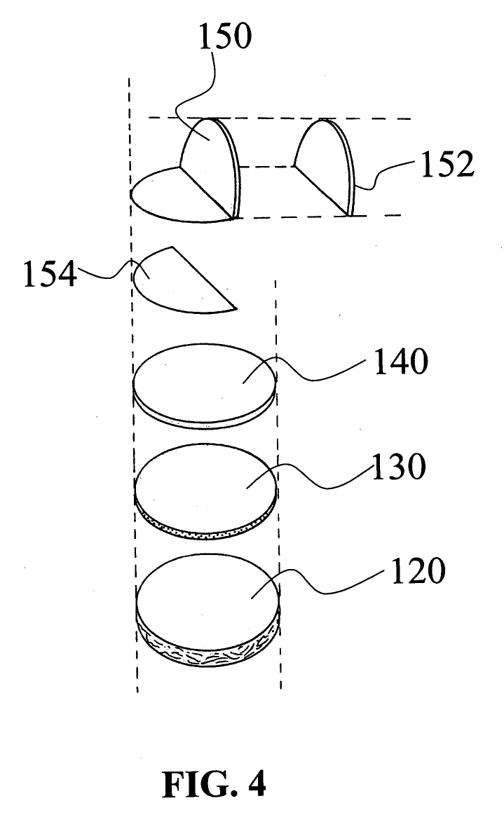

FIG. 4 depicts a further embodiment of the invention. In this embodiment, reactive member 130 is disposed between collection member 120 and clear backing 140, as in the previous embodiments. However, a thin layer of clear adhesive 154 is disposed between clear backing 140 and grip 150. A thin sheet of siliconized paper 152 is also adhered to grip 150 for reinforcing the grip.

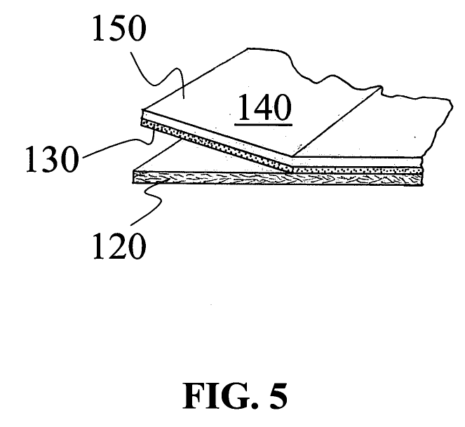

FIG. 5 depicts a further embodiment of the invention wherein the reactive member 130 may be selectively disengaged from collection member 120. The reactive member forms a portion of the grip 150 in this embodiment.

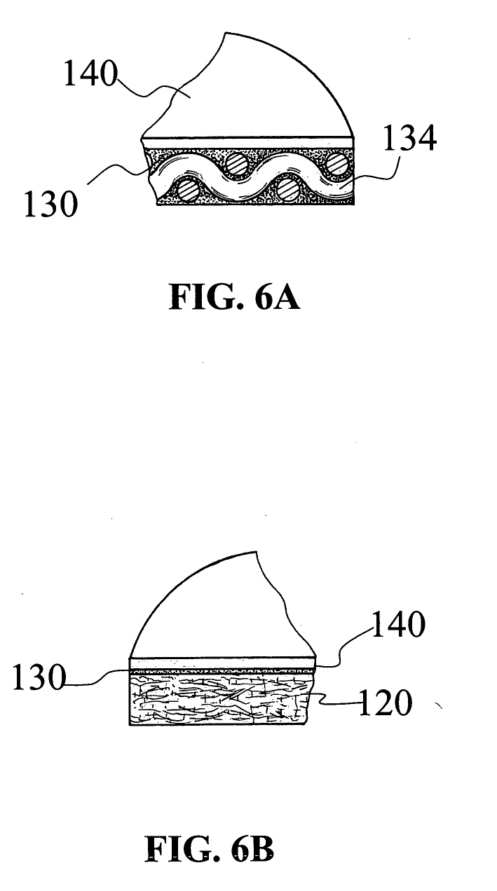

FIGS. 6A and 6B show another embodiment of the invention that includes mesh 134 disposed within reactive member 130. Mesh 134 acts as a media for supporting active chemicals thereon. Reactive member 130 is disposed between clear backing member 140 and collection member 120. In this embodiment, collection member 120 comprises microfibers of nonwoven textile material.

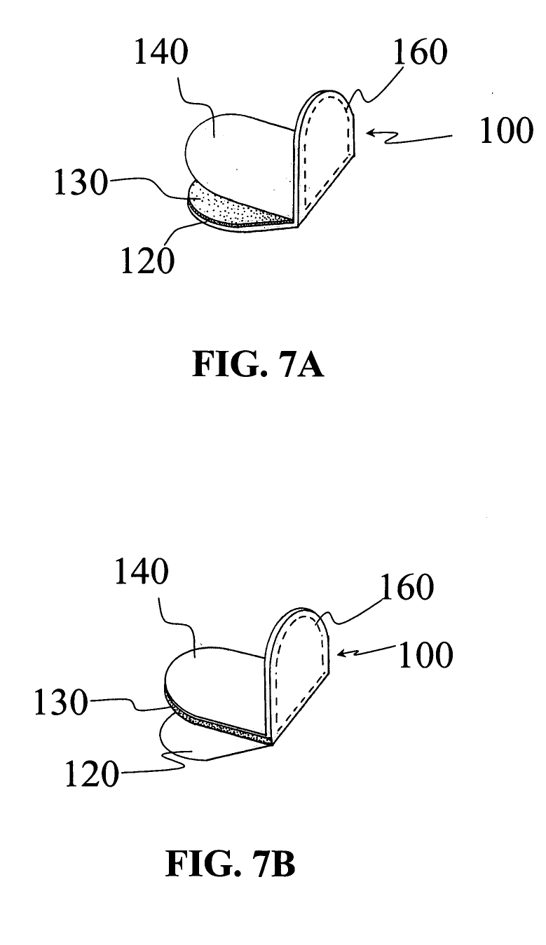

FIGS. 7A and 7B show another embodiment of the invention wherein the collection member 120, reactive member 130 and clear backing member 140 are affixed together at one end via seams 160. Thus, the members may be easily separated as shown.

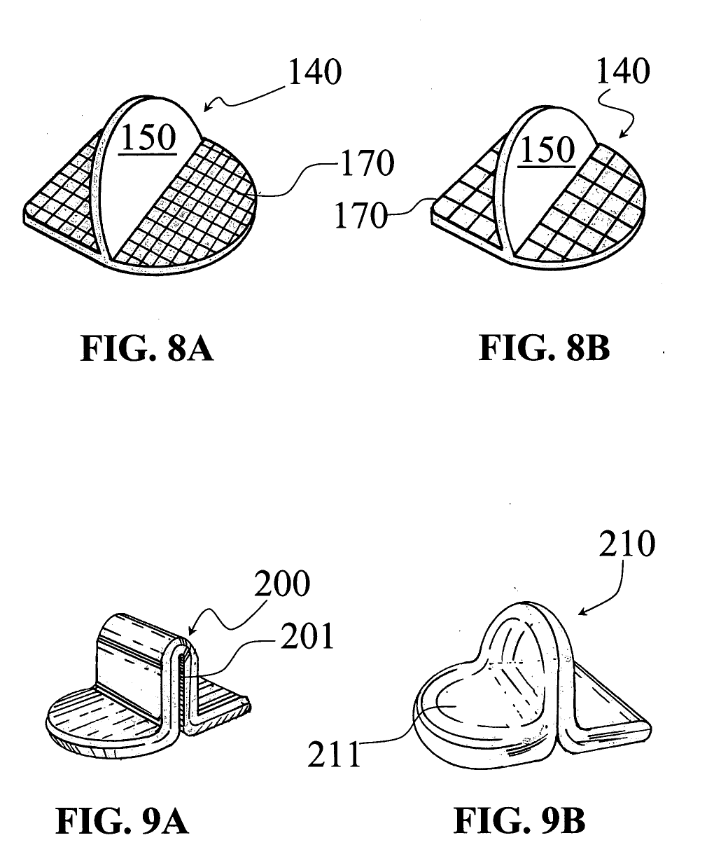

FIGS. 8 are embodiments of the invention wherein a grid work of lines 170 are provided on the clear backing member 140 for allowing a quantitative analysis of a collected sample. In this embodiment, the more cells that are changed in color indicate a more heavily contaminated surface area. In FIG. 8A, the lines 170 are closer together than those shown in FIG. 8B. Thus, a more accurate quantitative analysis may be conducted by use of the pattern FIG. 8A than 8B.

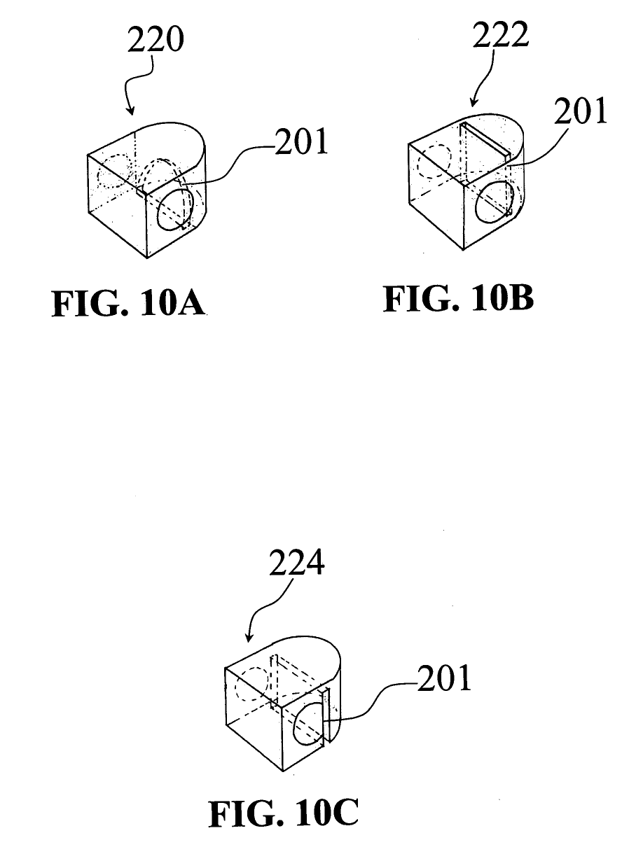

FIG. 9A depicts a handle 200 for use with the swap 100. A slot 201 is included for accommodating grip 150. The handle 200 ensures equal distribution of weight onto the swab as it passes across a surface that is being tested. FIG. 9B depicts a different handle 210 that includes an area 211 for accommodating a thumb of the user. Both handles 200 and 210 may comprise a rigid material such as plexiglass or polycarbonate. FIGS. 10A-C show transparent block style handles 220, 222, 224 for use with different shaped grips. Each includes a slot 201 for accommodating a grip 150.

As can be seen in FIG. 11, the grip 150 of a swab 100 may be held between the thumb and forefinger of a tester. The collection member 120 is press against and passed across the surface that is being tested. Dirt and other unharmful materials are filtered by the collection member 120. Harmful substances that react to chemicals in the reactive member 130 cause an optochemical change in the color of the reactive member 130 that is easily viewed through the clear backing member 140.

We claim:

1. A device for real-time detection of harmful substances on a surface comprising a swab that includes:
a collection member comprising an inert material that does not react to the harmful substances;
a reactive member disposed next to the collection member and impregnated with a chemical that produces an optochemical change in the reactive member when coming into contact with the harmful substances; and
a clear support member disposed next to the reactive member opposite the collection member and through which the optochemical change in the reactive member may be viewed.

2. The device of claim 1 further comprising a collection member selected from a group consisting of a cloth, woven fabric, unwoven fabric and felt.

3. The device of claim 1 wherein material comprising said collection member has a pore size of preferably between 1 and 40 microns.

4. The device of claim 1 further comprising a collection member selected from a group consisting of polyester, polypropylene, polyethylene and polyamide.

5. The device of claim 1 further comprising of a collection member impregnated or coated with an active ingredient that reacts with collected analyte to transform the collected analyte to another substance capable of reacting with said reactive member to produce an optochemical result.

6. The surface swab of claim 1 further having a shape selected from a group consisting of square, rectangular, half-circular and circular.

7. The reactive member of claim 1 further comprises an active ingredient carrier member and binding member.

8. The active member of claim 7 further comprises active ingredients capable of undergoing one of a chemical, a biochemical, and a physical reaction with a target analyte to produce an optochemical result.

9. The reactive member of claim 1 further includes a support substrate having a macroporous structure to support and encapsulate one of chemical and biochemical active ingredients that produce the optochemical change.

10. The reactive member of claim 9 further comprising a microporous and nonporous material that supports and encapsulates the chemical and biochemical active ingredients.

11. The reactive member of claim 10 further comprising a binding substrate to bind and localize said chemical and biochemical active ingredients to one of the microporous and nonporous material.

12. The device of claim 10 wherein said microporous and nonporous material includes one or more selected from group consisting of silica, alumina, zeolite, porcelain and inert material.

13. The reactive member of claim 1 further comprises of one or more selected from a group consisting of filter paper and a porous inert membrane impregnated with an active ingredient capable of undergoing a chemical reaction to produce a visible color change indicating the presence of the harmful substance.

14. The clear support member of claim 1 further comprises of one or more selected from a group consisting of polypropylene, polyesters, polycarbonates, polyamicles, or a clear inert polymer.

15. The clean support member of claim 14 having a thickness of between 5 and 25 mils.

16. The collection member of claim 1 further includes openings that allow materials to be tested to contact the reactive member to cause a color change that may be viewed through the clear support member.

17. A method of detecting harmful substances on a surface with a surface wipe that comprises a collection media, a reactive media and a support media, said method comprising:
collecting a sample of analyte by passing the surface wipe across a surface to be tested;
filtering dust, dirt and other contaminants through the collection media;
detecting the presence of the harmful substance by providing a color change in the reactive media.

18. A surface wipe that detects the presence of a toxic chemical on a surface to be tested, said surface wipe comprising:
a collection media that contacts the surface to be tested and filters contaminants, dust and dirt;
a reactive media disposed next to the collection media and impregnated with chemicals that react to the toxic chemical to produce a color change; and,
a clear backing disposed next to the reactive media and through which the color change may be viewed.

19. The surface wipe of claim 18 further including a grip attached to the clear backing.
